(19) United States
(12) Patent Application Publication
(10) Pub. No.: US 2026/0328250 A1
(43) Pub. Date: Oct. 22, 2026

(54) CAGE, ROLLING BEARING, AND METHOD FOR ASSEMBLING ROLLING BEARING

(71) Applicant: JTEKT CORPORATION, Kariya-shi, Aichi (JP)

(72) Inventors: Hirotaka YASUDA, Kashihara-shi (JP); Kunio HIGUCHI, Kashihara-shi (JP); Yasumasa HYAKUTANI, Kitakaturagi-gun (JP)

(73) Assignee: JTEKT CORPORATION, Kariya-shi, Aichi (JP)

(21) Appl. No.: 19/111,389

(22) PCT Filed: Dec. 12, 2022
(86) PCT No.: PCT/JP2022/045728

§ 371 Date: Mar. 13, 2025

(30) Foreign Application Priority Data
Oct. 3, 2022 (WO) PCT/JP2022/036956

(51) Int. Cl. F16C 33/46; F16C 19/26; F16C 33/56

(52) U.S. Cl. CPC F16C 33/4664; F16C 19/26; F16C 33/4676; F16C 33/56; F16C 2208/00

(57) ABSTRACT

A cage includes a first wall facing first end faces of rollers of a rolling bearing, a second wall facing second end faces of the rollers, and a plurality of bars connecting the first wall and the second wall. The space between a pair of bars and between the first wall and the second wall serves as a pocket that stores a roller. The bar includes, on either or both of a first side and a second side in a radial direction, a retaining portion that prevents the roller stored in the pocket from falling out. A connection portion between the first wall and the bar includes a first concave surface located on the first side in the radial direction and a second concave surface located on the second side in the radial direction. The first concave surface is recessed more than the second concave surface.

### TECHNICAL FIELD

The present invention relates to cages, rolling bearings, and methods for assembling a rolling bearing.

### BACKGROUND ART

A rolling bearing includes an inner ring, an outer ring, a plurality of rolling elements, and a cage that holds the plurality of rolling elements. The cage has a plurality of pockets that store the rolling elements. A cage disclosed in Patent Document 1 includes a first annular body facing first end faces of rollers that are rolling elements, a second annular body facing second end faces of the rollers, and a plurality of bars connecting the first annular body and the second annular body. The space between a pair of bars and between the first annular body and the second annular body serves as a pocket that stores a roller.

### RELATED ART DOCUMENTS

### Patent Documents

Patent Document 1: Japanese Unexamined Patent Application Publication No. 2021-143765 (JP 2021-143765 A)

### SUMMARY OF THE INVENTION

### Problem to be Solved by the Invention

FIG. 21 is a perspective view showing part of a conventional cage. FIG. 22 is a diagram showing a pocket of the conventional cage as viewed in an axial direction of a roller. A cage 90 includes protrusions 92 as retaining portions that prevent rollers 99 stored in pockets 91 from falling out. Two protrusions 92 are located at one pocket 91. The dimension B between the two protrusions 92 is smaller than the diameter D of the roller 99. Therefore, when installing rollers 99 into pockets 91, the rollers 99 press the protrusions 92, so that bars 93 of the cage 90 are elastically deformed. Stress concentration thus occurs at connection portions 95 between each bar 93 and each annular body 94.

In order to reduce the stress concentration, recessed surfaces 96 are provided at the connection portions 95 between each bar 93 and each annular body 94. The recessed surfaces 96 are formed along the entire length from an outer peripheral surface 97 to an inner peripheral surface 98 of the cage 90. Since each recessed surface 96 is formed over a large area, the connection portions 95 have a small thickness, so that the cage 90 may not have enough strength.

The recessed surfaces 96 also reduce the contact area between each roller 99 and each annular body 94. Each roller 99 has a recessed portion 100 radially inward of its end face 99a due to manufacturing. The end face 99a of each roller 99 contacts the annular body 94. However, when the recessed portion 100 is large and the recessed surfaces 96 are formed along a great length in a radial direction, the contact area between the roller 99 and the annular body 94 is small. Therefore, particularly when the cage 90 is made of resin, part of the annular body 94 tends to be worn away by contact with the end faces 99a of the rollers 99.

The present disclosure can reduce stress concentration that occurs during installation of rollers into pockets of a cage of a rolling bearing and can reduce wear due to contact with the rollers.

### Means for Solving the Problem

A cage according to an embodiment of the present invention is a cage including a first wall facing a first end face of a roller of a rolling bearing, a second wall facing a second end face of the roller, and a plurality of bars connecting the first wall and the second wall. A space between a pair of the bars and between the first wall and the second wall serves as a pocket that stores the roller. The bar includes, on either or both of a first side and a second side in a radial direction, a retaining portion that prevents the roller stored in the pocket from falling out. A connection portion between the first wall and the bar includes a first concave surface located on the first side in the radial direction and a second concave surface located on the second side in the radial direction. The first concave surface is recessed more than the second concave surface.

### Effects of the Invention

The cage of the present disclosure can reduce stress concentration that occurs during installation of the rollers into the pockets of the cage and can thus reduce wear due to contact with the rollers.

### BRIEF DESCRIPTION OF THE DRAWINGS

FIG. 1 is a sectional view showing an embodiment of a rolling bearing of the present invention.

FIG. 2 is a perspective view of a cage.

FIG. 3 is an illustration of a roller stored in a pocket as viewed along the central axis of the roller.

FIG. 4 is the illustration shown in FIG. 3 without the roller.

FIG. 5 is an enlarged view of part of the cage.

FIG. 6 is a sectional view of a region of a first connection portion where a concave arc surface is formed, as viewed in a radial direction of the cage.

FIG. 7 is a sectional view of a region of the first connection portion where a recessed surface is formed, as viewed in the radial direction of the cage.

FIG. 8 is a perspective view showing a modification of the cage shown in FIG. 5.

FIG. 9 is a diagram illustrating the cage shown in FIG. 8, showing a pocket as viewed along the central axis of a roller.

FIG. 10 is a sectional view showing another embodiment of the rolling bearing.

FIG. 11 is a perspective view of a cage of the rolling bearing shown in FIG. 10.

FIG. 12 is a perspective view showing a modification of the cage shown in FIG. 11.

FIG. 13 is a sectional view showing still another embodiment of the rolling bearing.

FIG. 14 is a front view showing part of the rolling bearing shown in FIG. 13.

FIG. 15 is a perspective view of a cage segment.

FIG. 16 is a diagram showing a modification of the cage shown in FIG. 8.

FIG. 17 is a diagram showing a modification of the cage shown in FIG. 9.

FIG. 18 is an enlarged sectional view showing part of the rolling bearing.

FIG. 19 is a diagram showing a further modification of the cage.

FIG. 20 is a diagram showing a further modification of the cage shown in FIGS. 11 and 12.

FIG. 21 is a perspective view showing part of a conventional cage.

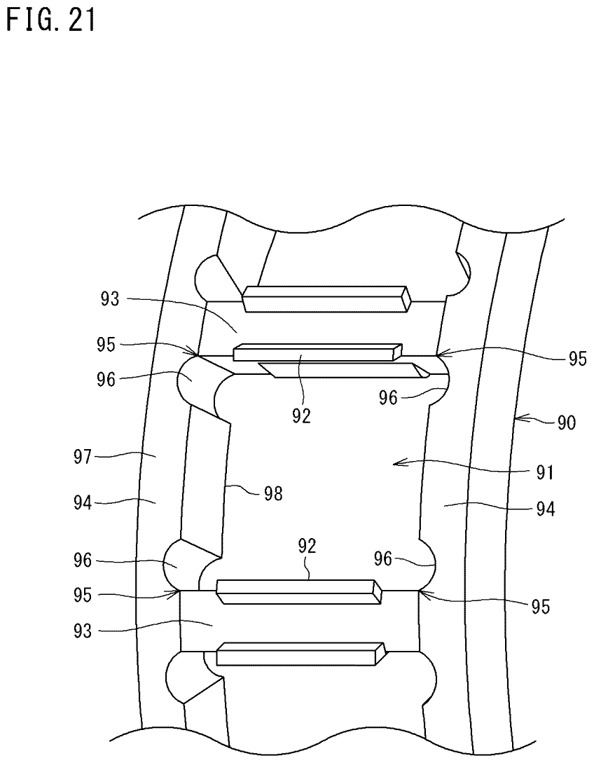

FIG. 22 is a diagram showing a pocket of the conventional cage as viewed in an axial direction of a roller.

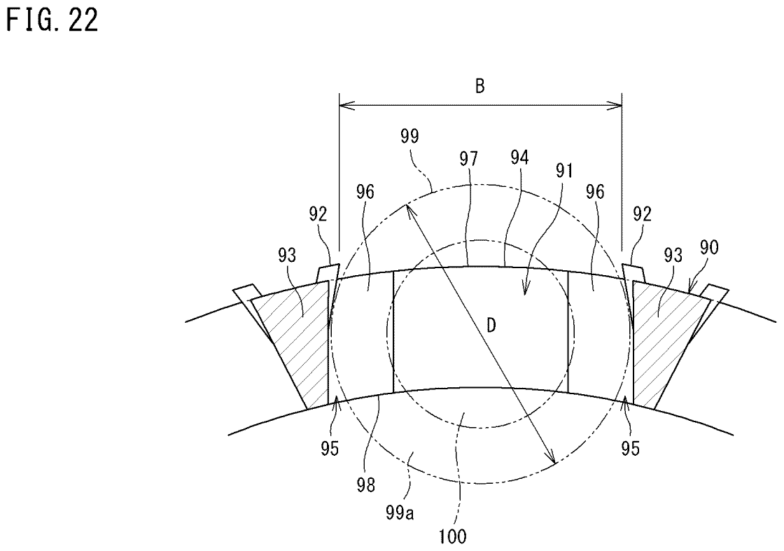

### MODES FOR CARRYING OUT THE INVENTION

### Overview of Embodiments of Present Invention

An overview of embodiments of the present invention will be provided below.
(1) A cage according to an embodiment of the present invention is a cage including a first wall facing a first end face of a roller of a rolling bearing, a second wall facing a second end face of the roller, and a plurality of bars connecting the first wall and the second wall. A space between a pair of the bars and between the first wall and the second wall serves as a pocket that stores the roller. The bar includes, on either or both of a first side and a second side in a radial direction, a retaining portion that prevents the roller stored in the pocket from falling out. A connection portion between the first wall and the bar includes a first concave surface located on the first side in the radial direction and a second concave surface located on the second side in the radial direction. The first concave surface is recessed more than the second concave surface.

According to this cage, the roller presses the retaining portions, so that the bars are elastically deformed in order to allow the roller to be installed into the pocket. In this case, the first concave surface can reduce stress concentration on the connection portion. The first concave surface is present on the first side in the radial direction, but is not present on the second side in the radial direction. This configuration can provide a larger contact area between the first end face of the roller and the first wall than in the case where the first concave surface is present along the entire length from the first side to the second side in the radial direction. Wear of the cage due to a small contact area can thus be reduced.
(2) Preferably, the first concave surface includes such a tilted surface that a clearance between the first concave surface and the roller becomes gradually larger away from the second concave surface in the radial direction. In this case, the cage can enhance the function to provide a large contact area without sacrificing the function to reduce the stress concentration.
(3) The cage is preferably made of resin. The first wall preferably includes a connecting surface that connects the first concave surface located at one bar of the pair of bars adjacent to each other and the first concave surface located at the other bar. The connecting surface is preferably such a surface that a clearance between the connecting surface and the roller becomes gradually larger toward the first side in the radial direction. In this case, when the cage is molded using a mold, the mold can be easily removed toward the first side in the radial direction.
(4) Preferably, the first wall is a first annular body having a ring shape, and the second wall is a second annular body having a ring shape. In this case, the cage is an annular cage having a plurality of the pockets, and the roller is stored in each of the pockets.
(5) Preferably, the cage is composed of a plurality of cage segments located in an annular space between an inner ring and an outer ring of the rolling bearing, and each of the cage segments includes the first wall, the second wall, and two of the bars. In this case, the cage is composed of the plurality of cage segments.
(6) Preferably, an edge on the second side in the radial direction of the connecting surface is located closer to the first side in the radial direction than an end on the second side in the radial direction of the first concave surface located at the one bar and an end on the second side in the radial direction of the first concave surface located at the other bar. This configuration increases the area of a surface of the first wall that the roller can contact. Wear of this surface due to sliding contact of the roller can thus be prevented.
(7) A rolling bearing according to an embodiment of the present invention includes: an inner ring; an outer ring; a plurality of rollers located between the inner ring and the outer ring; and a cage that holds the rollers. Regarding the cage of the rolling bearing, stress concentration that occurs during installation of the rollers into pockets is reduced, and wear due to contact with the rollers can be reduced.
(8) A method for assembling the rolling bearing according to the embodiment of the present invention includes a combining step of installing the rollers into the pockets from either or both of the first side and the second side in the radial direction to obtain a unit of the cage and the rollers. In the combining step, the rollers are installed into the pockets in such a manner that the rollers press the retaining portions to elastically deform the bars.

The above assembling method reduces stress concentration that occurs during installation of the rollers into the pockets. In the cage of the assembled rolling bearing, wear due to contact with the rollers is reduced.

### Details of Embodiments of Present Invention Hereinafter, embodiments of the present invention will be described.

### First Embodiment of Rolling Bearing

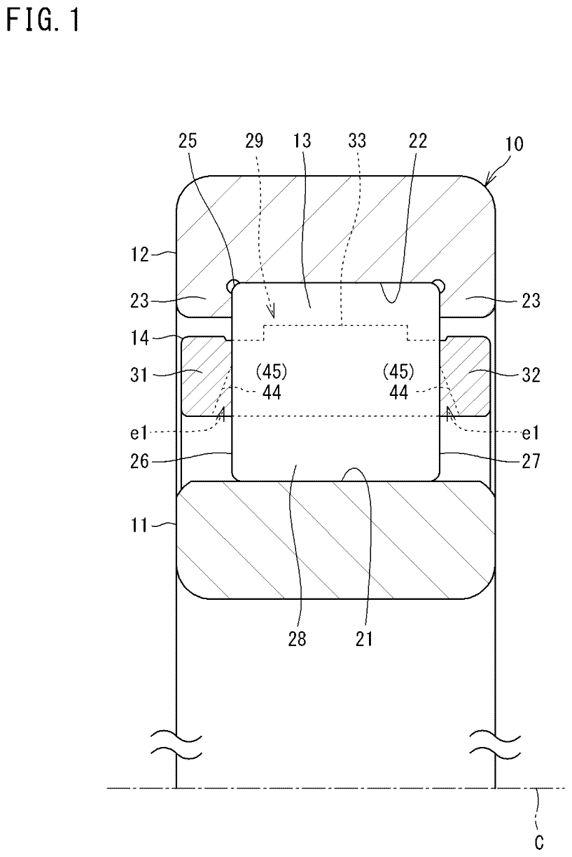

FIG. 1 is a sectional view showing an embodiment of a rolling bearing of the present invention. A rolling bearing 10 shown in FIG. 1 is a cylindrical roller bearing, and includes an inner ring 11, an outer ring 12, a plurality of rollers (cylindrical rollers) 13, and a cage 14 that holds the plurality of rollers 13. The inner ring 11 and the outer ring 12 have a ring shape. The rollers 13 are located between the inner ring 11 and the outer ring 12. The central axis of the inner ring 11 and the central axis of the outer ring coincide with each other, and these central axes are the central axis C of the rolling bearing 10.

The cage 14 shown in FIG. 1 has an annular shape. Regarding each embodiment of the present invention, a state in which the central axis of the cage 14 coincides with the central axis C of the rolling bearing 10 will be described. Regarding the inner ring 11, the outer ring 12, and the cage 14, a direction parallel to the central axis Cis defined as the “axial direction.” A direction perpendicular to the central axis C is defined as the “radial direction.” A direction along a circle about the central axis C is defined as the “circumferential direction.”

The inner ring 11 has an inner ring raceway surface 21 in its outer peripheral surface. The outer ring 12 has an outer ring raceway surface 22 in its inner peripheral surface. The outer ring 12 has ribs 23 on both sides in the axial direction of the outer ring raceway surface 22. The rollers 13 have a cylindrical shape, and each include a first end face 26, a second end face 27, and an outer peripheral surface 28. The rollers 13 are in rolling contact with the inner ring raceway surface 21 and the outer ring raceway surface 22. The inner ring 11, the outer ring 12, and the rollers 13 are made of steel. The cage 14 is made of resin.

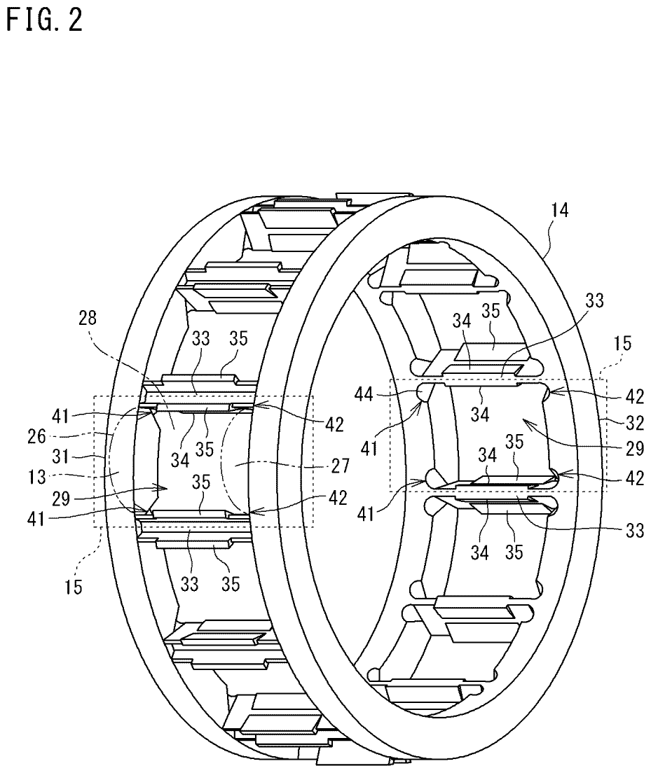

FIG. 2 is a perspective view of the cage 14. The cage 14 includes a first annular body 31, a second annular body 32, and a plurality of bars 33. The first annular body 31 has a ring shape and serves as a first wall facing the first end faces 26 of the rollers 13. The second annular body 32 has a ring shape and serves as a second wall facing the second end faces 27 of the rollers 13. The bars 33 connect the first annular body 31 and the second annular body 32. The bars 33 face the outer peripheral surfaces 28 of the rollers 13. The space between a pair of bars 33 adjacent to each other in the circumferential direction and between the first annular body 31 and the second annular body 32 serves as a pocket 29 that stores a roller 13.

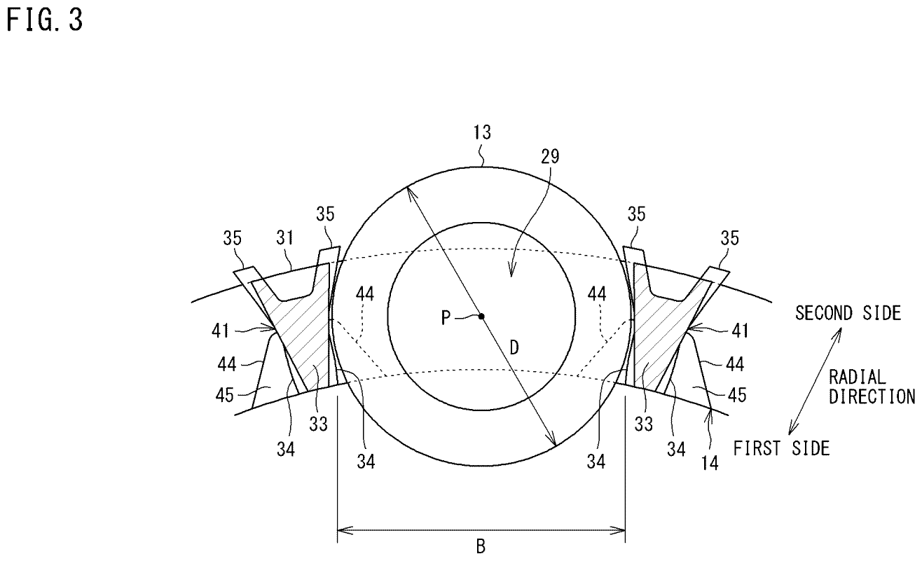

The bars 33 each have, on the inner peripheral side of the cage 14, inner retaining portions 34 that prevent the rollers 13 stored in the pockets 29 from falling out. The retaining portions 34 are protrusions each provided along a partial length in the axial direction of the bar 33 and protruding from the bar 33. FIG. 3 is an illustration of a roller 13 stored in a pocket 29 as viewed along the central axis P of the roller 13. When the roller 13 stored in the pocket 29 is displaced inward in the radial direction of the cage 14, the roller 13 comes into contact with the retaining portions 34 and is prevented from falling out.

The bars 33 each have, on the outer peripheral side of the cage 14, outer retaining portions 35 that prevent the rollers 13 stored in the pockets 29 from falling out. The retaining portions 35 are protrusions each provided along a partial length in the axial direction of the bar 33 (see FIG. 2) and protruding from the bar 33. The outer retaining portions 35 may be omitted.

A method for assembling the rolling bearing 10 shown in FIG. 1 is as follows. With the cage 14 placed on the inner peripheral side of the outer ring 12, the rollers 13 are installed into the pockets 29 of the cage 14. The rollers 13 are installed into the pockets 29 from the inner peripheral side of the cage 14. As shown in FIG. 3, when looking at one pocket 29, the dimension B between the two retaining portions 34 is smaller than the diameter D of the roller 13. Therefore, when installing a roller 13 into the pocket 29, the roller 13 presses the retaining portions 34, so that the bars 33 are elastically deformed. All of the rollers 13 are installed into the pockets 29 of the cage 14 placed in the outer ring 12 to form an outer ring assembly. The outer ring assembly is combined with the inner ring 11 to form the rolling bearing 10.

In FIG. 2, a portion where the first annular body 31 and one bar 33 are connected is a first connection portion 41. A portion where the second annular body 32 and one bar 33 are connected is a second connection portion 42. When looking at a unit pocket portion 15 that forms one pocket 29, one roller 13 stored in this pocket 29 is sandwiched between two bars 33 in the circumferential direction of the cage 14. Therefore, there are two first connection portions 41 in one pocket portion 15, and there are two second connection portions 42 in one pocket portion 15.

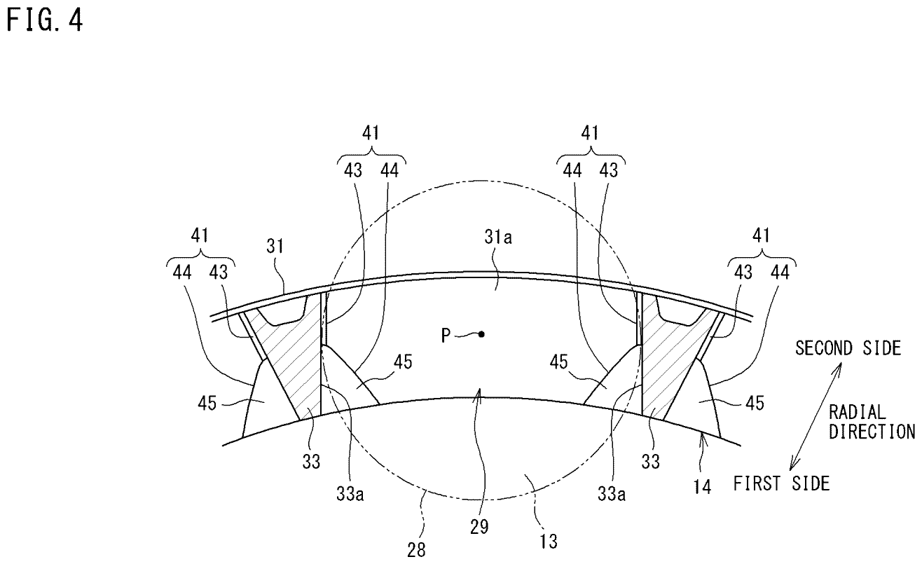

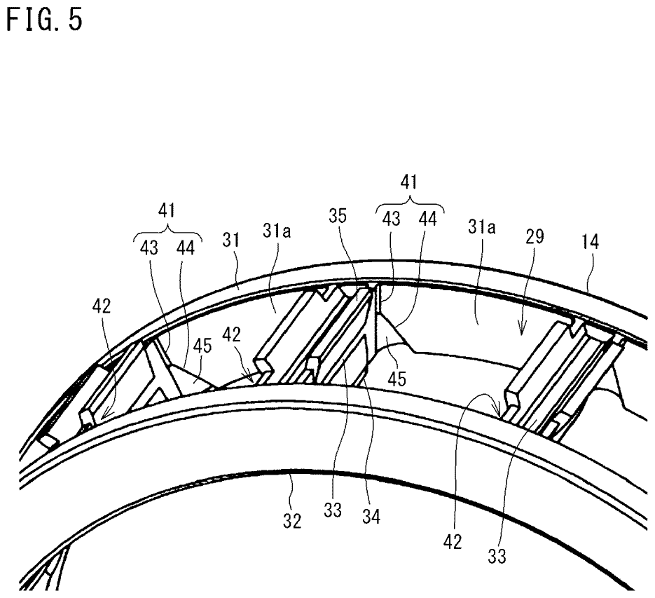

FIG. 4 is the illustration shown in FIG. 3 without the roller 13. FIG. 5 is an enlarged view of part of the cage 14. The first connection portion 41 has a concave arc surface (second concave surface) 43 located on the outer peripheral side and a recessed surface (first concave surface) 44 located on the inner peripheral side. The concave arc surface 43 is a surface having a shape conforming to a cylinder with a very small radius. The recessed surface 44 is a surface that is recessed more than the concave arc surface 43. The concave arc surface 43 and the recessed surface 44 are also provided in the second connection portion 42. That is, the second connection portion 42 has a concave arc surface 43 located on the outer peripheral side and a recessed surface 44 located on the inner peripheral side. In the present embodiment, the concave arc surface 43 of the first connection portion 41 and the concave arc surface 43 of the second connection portion 42 have the same shape, and the recessed surface 44 of the first connection portion 41 and the recessed surface 44 of the second connection portion 42 have the same shape.

The recessed surface 44 is a surface having a shape conforming to a cone. The recessed surface 44 has a tilted surface 45 that makes the recess gradually deeper away from the concave arc surface 43 in the radial direction, i.e., toward the inner peripheral side. A clearance el between the recessed surface 44 and the end face 26 (27) of the roller 13 (see FIG. 1) becomes gradually larger toward the inner peripheral side due to the tilted surface 45.

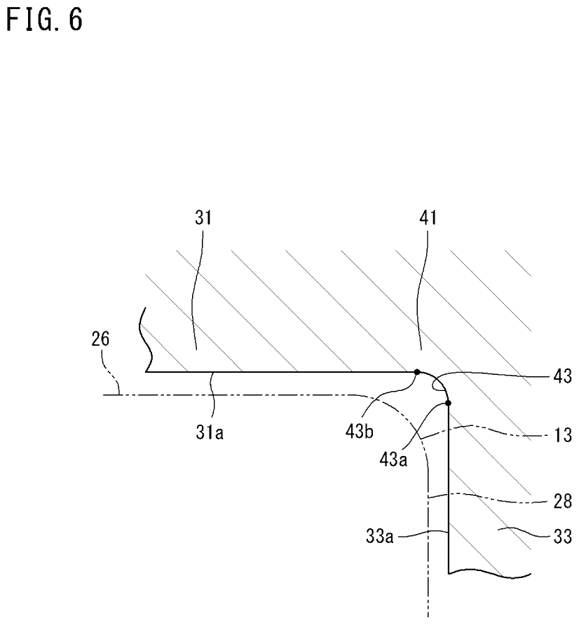

FIG. 6 is a sectional view of a region of the first connection portion 41 where the concave arc surface 43 is formed, as viewed in the radial direction of the cage 14. As shown in FIGS. 4 and 6, the bar 33 has a side surface 33a facing the outer peripheral surface 28 of the roller 13. The first annular body 31 has a side surface 31a that faces the first end face 26 of the roller 13. The concave arc surface 43 is a surface of a portion where the first annular body 31 and the bar 33 meet, and has a concave arc section as viewed in the radial direction (see FIG. 6). In the section shown in FIG. 6, the side surface 33a of the bar 33 is along a tangent line at a first end 43a of the concave arc surface 43. The side surface 31a of the first annular body 31 is along a tangent line at a second end 43b of the concave arc surface 43.

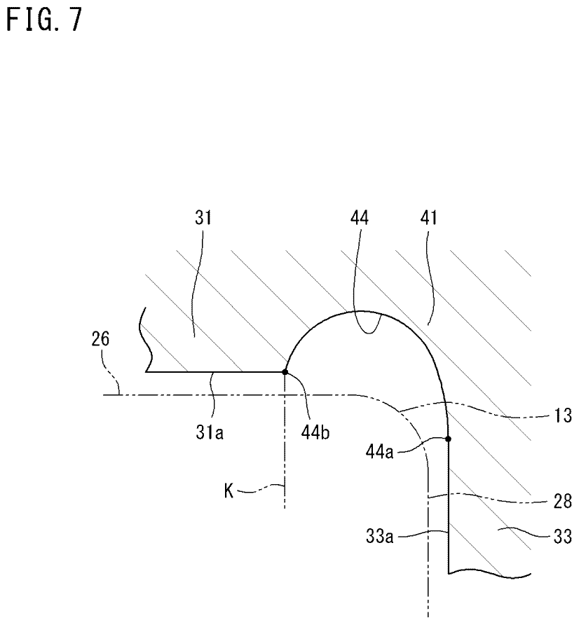

FIG. 7 is a sectional view of a region of the first connection portion 41 where the recessed surface 44 is formed, as viewed in the radial direction of the cage 14. As shown in FIGS. 4 and 7, the recessed surface 44 is a surface of a portion where the first annular body 31 and the bar 33 meet, and has a concave arc section as viewed in the radial direction (see FIG. 7). In the section shown in FIG. 7, the side surface 33a of the bar 33 is along a tangent line at a first end 44a of the recessed surface 44. The side surface 31a of the first annular body 31 intersects a tangent line K at a second end 44b of the recessed surface 44. The recessed surface 44 is recessed from the side surface 31a of the first annular body 31 so as to be away from the end face 26 of the roller 13.

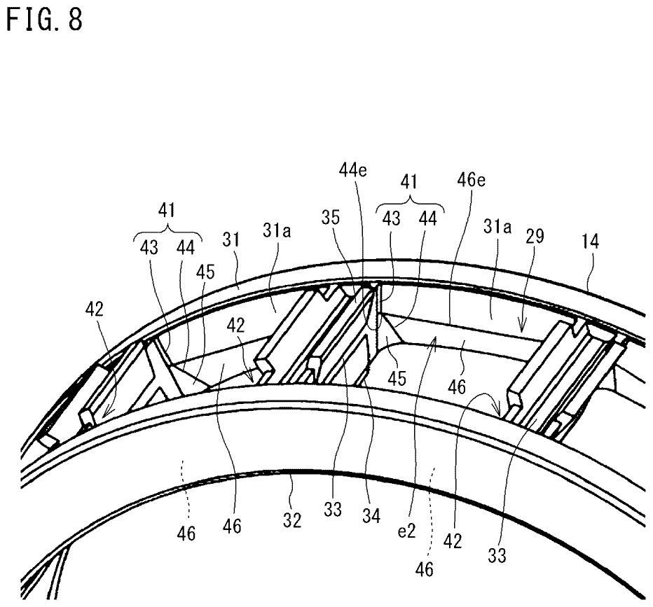

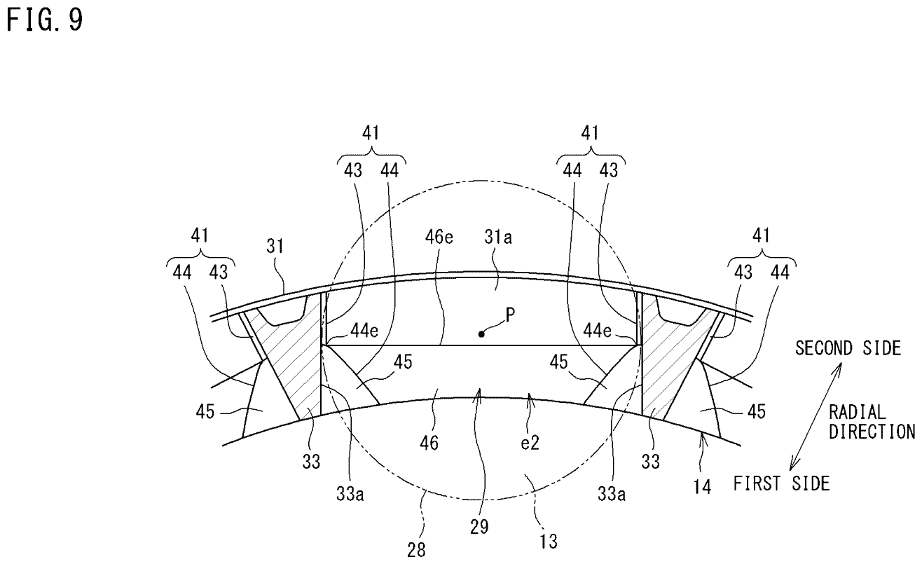

FIG. 8 is a perspective view showing a modification of the cage 14 shown in FIG. 5. FIG. 9 is a diagram illustrating the cage 14 shown in FIG. 8, showing a pocket 29 as viewed along the central axis P of a roller 13. Regarding the cage 14 shown in FIGS. 8 and 9 and the cage 14 shown in FIGS. 2 to 5, the same configurations are denoted by the same signs. In the cage 14 shown in FIGS. 8 and 9, as in the cage 14 shown in FIGS. 2 to 5, the first connection portion 41 has a concave arc surface 43 located on the outer peripheral side and a recessed surface 44 located on the inner peripheral side. The recessed surface 44 is a surface that is recessed more than the concave arc surface 43. The concave arc surface 43 and the recessed surface 44 are also provided in the second connection portion 42.

The cage 14 shown in FIGS. 8 and 9 is different from the cage 14 shown in FIGS. 2 to 5 in that the first annular body 31 has a connecting surface 46. In the case of the cage 14 shown in FIGS. 8 and 9, the first annular body 31 has the connecting surface 46 that connects the recessed surface 44 located at one bar 33 of a pair of bars 33 adjacent to each other in the circumferential direction and the recessed surface 44 located at the other bar 33. The connecting surface 46 is such a surface that a clearance e2 between the connecting surface 46 and the roller 13 (first end face 26) becomes gradually larger toward the inner peripheral side. The connecting surface 46 is a surface tilted from the side surface 31a of the first annular body 31. Like the first annular body 31, the second annular body 32 may also have a connecting surface 46. When the cage 14 is molded using a mold (injection molding mold), the mold can be easily removed in the radial direction due to the connecting surface 46.

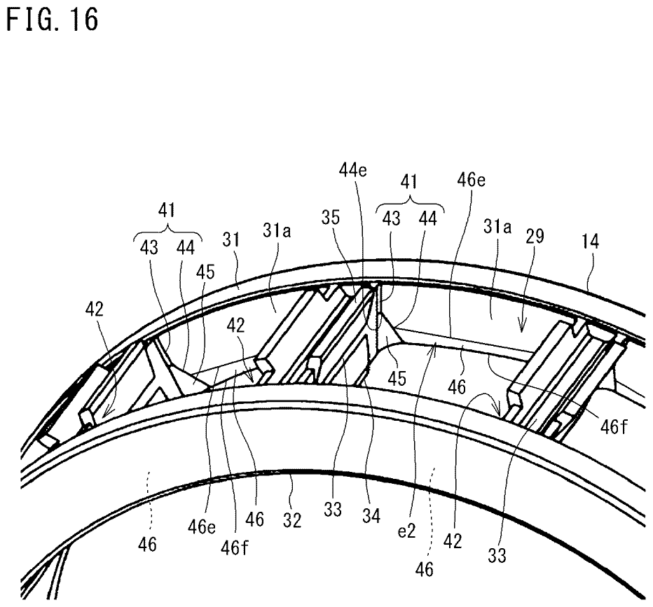

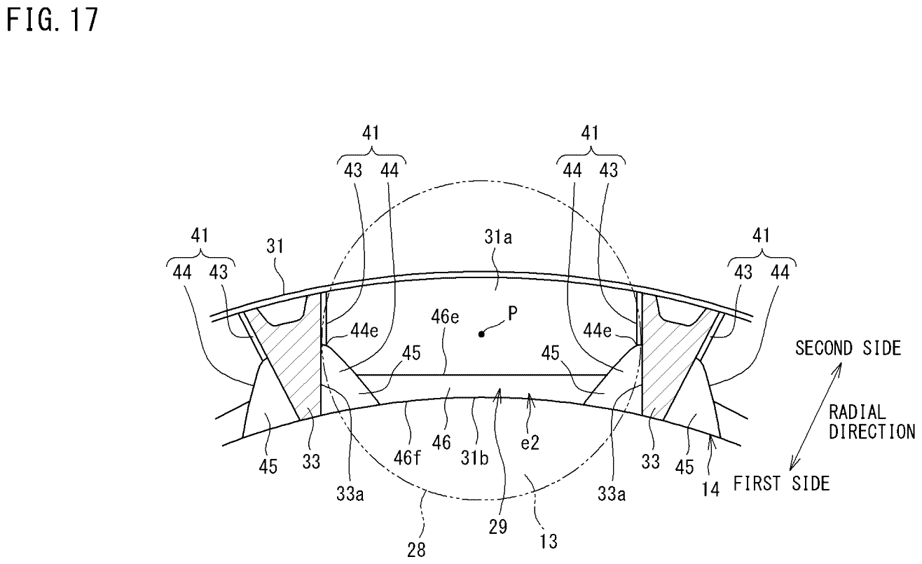

FIGS. 16 and 17 are diagrams showing a modification of the cage 14 shown in FIGS. 8 and 9. The form shown in FIGS. 16 and 17 is different from the form shown in FIGS. 8 and 9 in the connecting surface 46, but the other configurations are the same. The same configurations are denoted by the same signs, and description of the same configurations will be omitted. In the case of the modification shown in FIGS. 16 and 17, an outer edge 46e in the radial direction of the connecting surface 46 is located closer to the inner side in the radial direction, compared to the form shown in FIGS. 8 and 9. The edge 46e is a portion along a line where the connecting surface 46 and the side surface 31a meet.

Specifically, the edge 46e of the connecting surface 46 is located radially inward of outer ends 44e in the radial direction of the recessed surface 44 located at the one bar 33 and the recessed surface 44 located at the other bar 33. With this configuration, the area of the side surface 31a of the first annular body 31 that the roller 13 can contact is larger than in the case of the form shown in FIGS. 8 and 9. As a result, wear of the side surface 31a can be reduced.

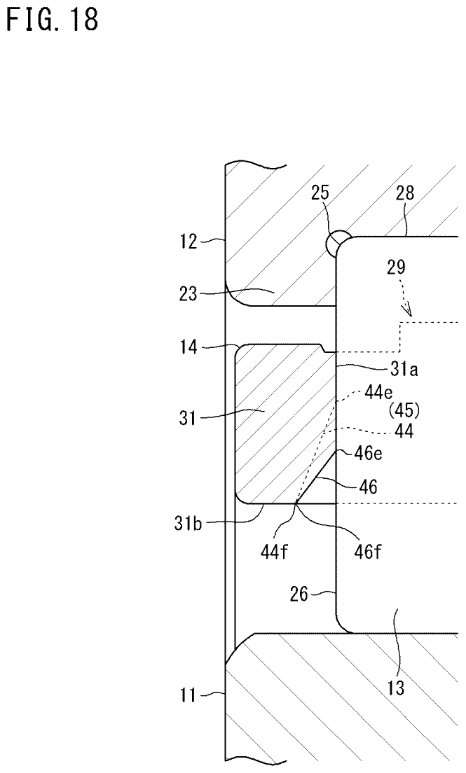

In the form shown in FIGS. 8 and 9 and the form shown in FIGS. 16 and 17, when installing a roller 13 into a pocket 29, an intersection portion 25 where the end face 26 and the outer peripheral surface 28 of the roller 13 meet (see FIG. 18) contacts the connecting surface 46. This facilitates installation of the roller 13 into the pocket 29. The intersection portion 25 is a convexly curved portion.

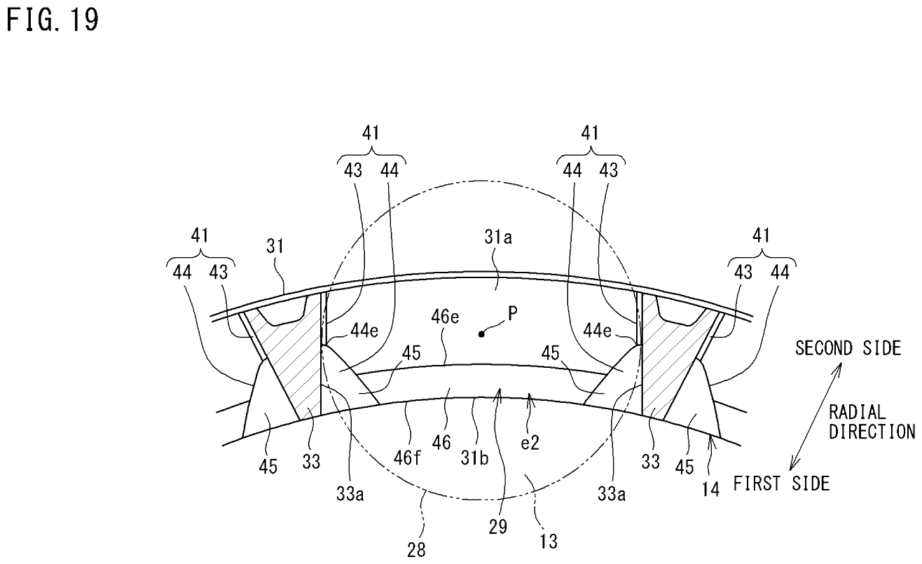

FIG. 19 is a diagram showing a further modification of the cage 14. In the form shown in FIG. 17, the edge 46e of the connecting surface 46 has a linear shape. In the case of the form shown in FIG. 19, on the other hand, the edge 46e of the connecting surface 46 has an arc shape. The arc shape is a shape conforming to a circle concentric with an arc shape of an inner peripheral surface 31b of the first annular body 31. The form shown in FIG. 17 more effectively increases the area of the side surface 31a. The form shown in FIG. 19 more effectively facilitates installation of the roller 13 into the pocket 29. The arc shape of the edge 46e may be an arc shape that does not conform to a circle concentric with the arc shape of the inner peripheral surface 31b of the first annular body 31.

In FIG. 18, the connecting surface 46 meets the inner peripheral surface 31b of the first annular body 31. A line where these surfaces meet is an inner edge 46f in the radial direction of the connecting surface 46. In the case of the form shown in FIG. 18, the inner edge 46f of the connecting surface 46 coincides with an inner end 44f in the radial direction of the recessed surface 44. However, the present invention is not limited to this, and the inner edge 46f of the connecting surface 46 may be located closer to the roller 13 in the axial direction than the inner end 44f of the recessed surface 44.

In each of the above forms of the cage 14, the second annular body 32 also has the same configuration as that of the connecting surface 46 of the first annular body 31.

### Second Embodiment of Rolling Bearing

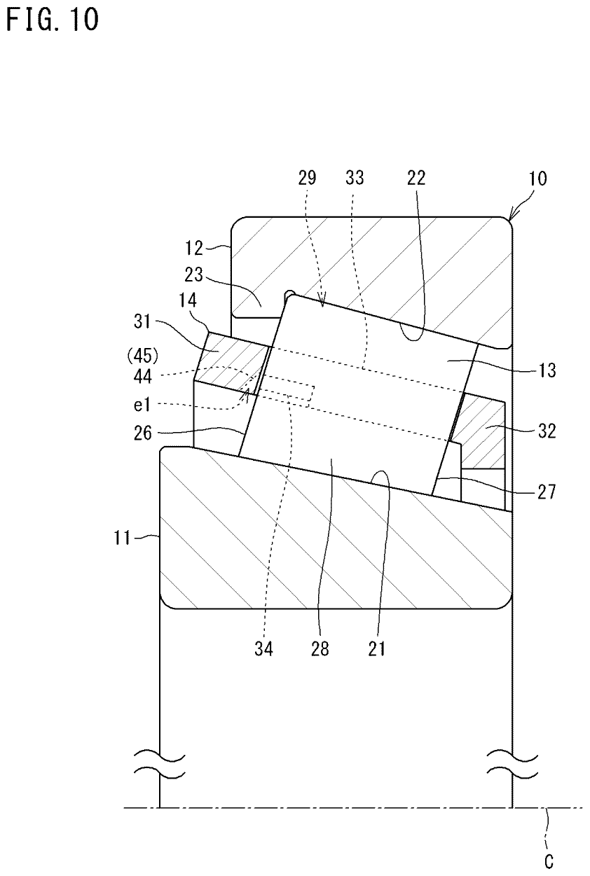

FIG. 10 is a sectional view showing another embodiment of the rolling bearing. The rolling bearing 10 shown in FIG. 10 is a tapered roller bearing, and the rollers 13 provided between the inner ring 11 and the outer ring 12 are tapered rollers. Regarding the rolling bearing 10 shown in FIG. 10, the same configurations as those of the rolling bearing 10 shown in FIG. 1 are denoted by the same signs, and description of the same configurations will be omitted.

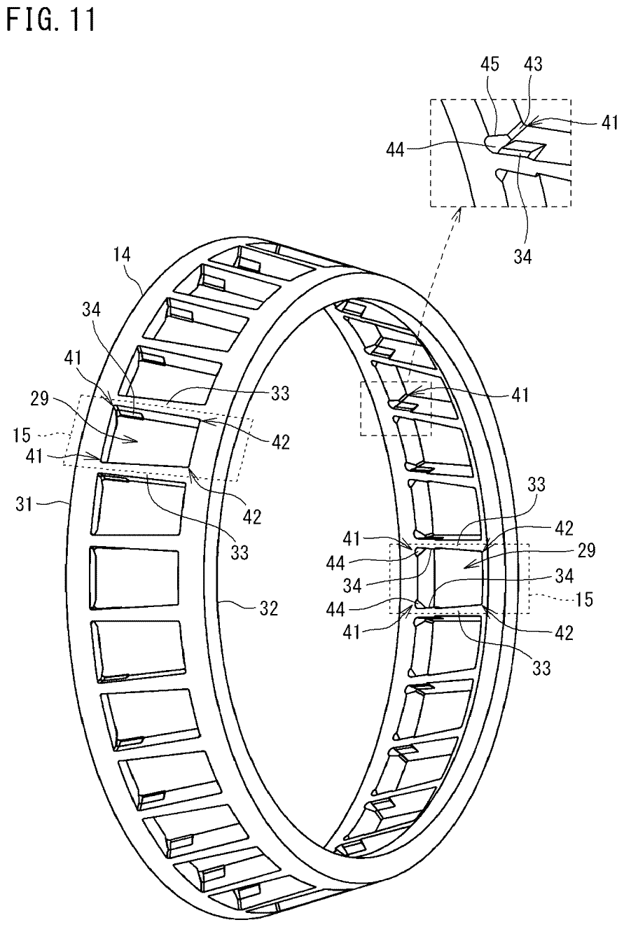

FIG. 11 is a perspective view of the cage 14 of the rolling bearing 10 shown in FIG. 10. The cage 14 includes a first annular body 31 with a large diameter, a second annular body 32 with a small diameter, and a plurality of bars 33. The first annular body 31 has a ring shape and serves as a first wall facing the first end faces 26 of the rollers 13. The second annular body 32 has a ring shape and serves as a second wall facing the second end faces 27 of the rollers 13. The bars 33 connect the first annular body 31 and the second annular body 32. The bars 33 face the outer peripheral surfaces 28 of the rollers 13. The space between a pair of bars 33 adjacent to each other in the circumferential direction and between the first annular body 31 and the second annular body 32 serves as a pocket 29 that stores a roller 13.

The bars 33 each have, on the inner peripheral side of the cage 14, inner retaining portions 34 that prevent the rollers 13 stored in the pockets 29 from falling out. The retaining portions 34 are protrusions each provided along a partial length in the axial direction of the bar 33 and protruding from the bar 33. In the form shown in FIG. 11, the retaining portions 34 are provided at a position closer to the first annular body 31 than to the second annular body 32. When the roller 13 stored in the pocket 29 is displaced inward in the radial direction of the cage 14, the roller 13 comes into contact with the retaining portions 34 and is prevented from falling out.

A method for assembling the rolling bearing 10 shown in FIG. 10 is as follows. With the cage 14 placed on the inner peripheral side of the outer ring 12, the rollers 13 are installed into the pockets 29 of the cage 14. The rollers 13 are installed into the pockets 29 from the inner peripheral side of the cage 14. As in the first embodiment (see FIG. 3), when looking at one pocket 29, the dimension between the two retaining portions 34 is smaller than the diameter of the roller 13 at the position where these retaining portions 34 are formed. Therefore, when installing a roller 13 into the pocket 29, the roller 13 presses the retaining portions 34, so that the bars 33 are elastically deformed. All of the rollers 13 are installed into the pockets 29 of the cage 14 placed in the outer ring 12 to form an outer ring assembly. The outer ring assembly is combined with the inner ring 11 to form the rolling bearing 10. During the installation, the end face of the roller 13 is pressed in along the first concave surface 44 using an installation jig. The roller 13 can thus be smoothly installed into the pocket 29.

In FIG. 11, a portion where the first annular body 31 and one bar 33 are connected is a first connection portion 41. A portion where the second annular body 32 and one bar 33 are connected is a second connection portion 42. There are two first connection portions 41 and two second connection portions 42 in one pocket portion 15 forming one pocket 29. The present embodiment is the same as the first embodiment (see FIG. 2) in this point as well.

The first connection portion 41 has a concave arc surface 43 located on the outer peripheral side and a recessed surface 44 located on the inner peripheral side. The concave arc surface 43 is a surface having a shape conforming to a cylinder with a very small radius. The recessed surface 44 is a surface that is recessed more than the concave arc surface 43. In the form shown in FIG. 11, the concave arc surface 43 and the recessed surface 44 are not provided in the second connection portion 42. However, the concave arc surface 43 and the recessed surface 44 may be provided in the second connection portion 42.

The recessed surface 44 is a surface having a shape conforming to a cone. The recessed surface 44 has a tilted surface 45 that makes the recess gradually deeper away from the concave arc surface 43 in the radial direction, i.e., toward the inner peripheral side. The clearance el between the recessed surface 44 and the end face 26 of the roller 13 (see FIG. 10) becomes gradually larger toward the inner peripheral side due to the tilted surface 45. The shapes of the concave arc surface 43 and the recessed surface 44 are the same as in the first embodiment (FIGS. 6 and 7).

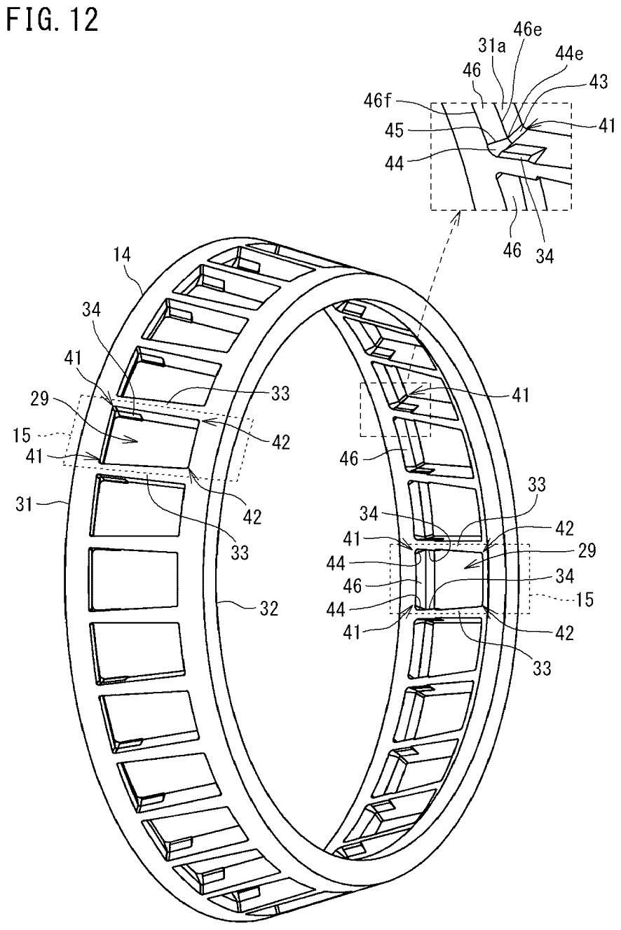

FIG. 12 is a perspective view showing a modification of the cage 14 shown in FIG. 11. The cage 14 shown in FIG. 12 is different from the cage 14 shown in FIG. 11 in that the first annular body 31 has a connecting surface 46. In the case of the cage 14 shown in FIG. 12, the first annular body 31 has the connecting surface 46 that connects the recessed surface 44 located at one bar 33 of a pair of bars 33 adjacent to each other in the circumferential direction and the recessed surface 44 located at the other bar 33. The connecting surface 46 is such a surface that the clearance between the connecting surface 46 and the roller 13 (first end face 26) becomes gradually larger toward the inner peripheral side. The connecting surface 46 is a surface tilted from the side surface 31a of the first annular body 31. The connecting surface 46 has the same configuration as the connecting surface 46 of the cage 14 shown in FIG. 8.

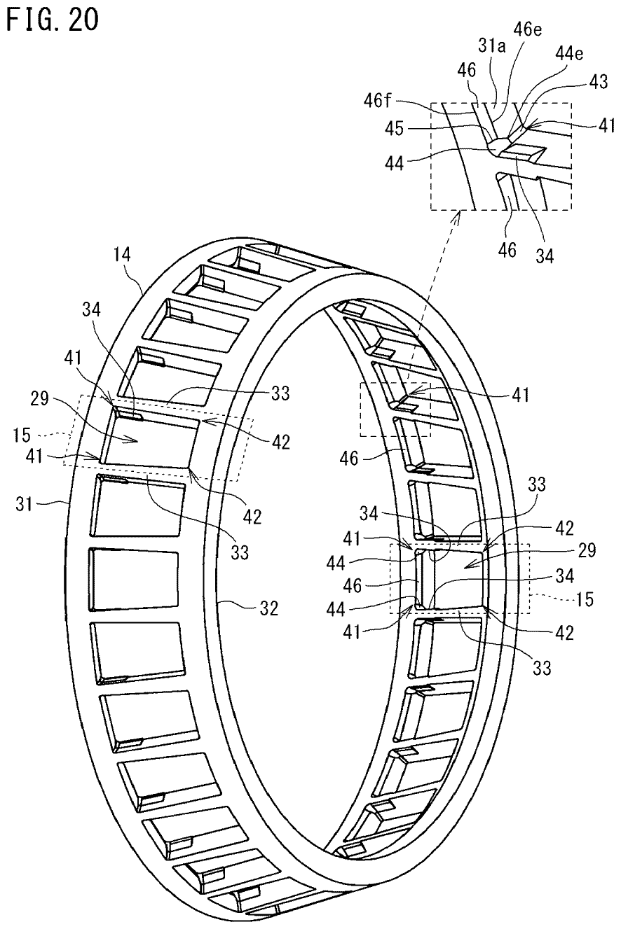

FIG. 20 is a diagram showing a further modification of the cage 14 shown in FIGS. 11 and 12. The form shown in FIG. 20 is different from the form shown in FIGS. 11 and 12 in the connecting surface 46, but the other configurations are the same. The same configurations are denoted by the same signs, and description of the same configurations will be omitted. In the case of the modification shown in FIG. 20, the outer edge 46e in the radial direction of the connecting surface 46 is located closer to the inner side in the radial direction, compared to the form shown in FIG. 12. The edge 46e is a portion along a line where the connecting surface 46 and the side surface 31a meet.

Specifically, the edge 46e of the connecting surface 46 is located radially inward of the outer ends 44e in the radial direction of the recessed surface 44 located at the one bar 33 and the recessed surface 44 located at the other bar 33. With this configuration, the area of the side surface 31a of the first annular body 31 that the roller 13 can contact is larger than in the case of the form shown in FIG. 12. As a result, wear of the side surface 31a can be reduced. The edge 46e of the connecting surface 46 may have a linear shape, or may be an arc shape as described in the form shown in FIG. 19. In each of the above forms of the cage 14, the second annular body 32 also has the same configuration as that of the connecting surface 46 of the first annular body 31.

### Third Embodiment of Rolling Bearing

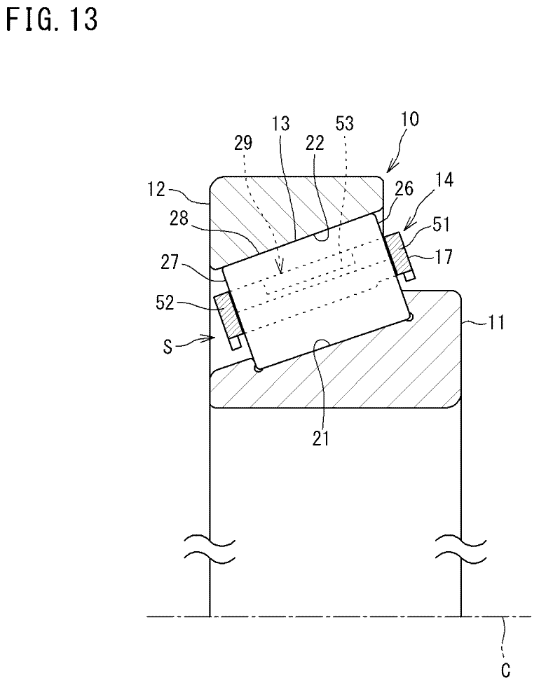

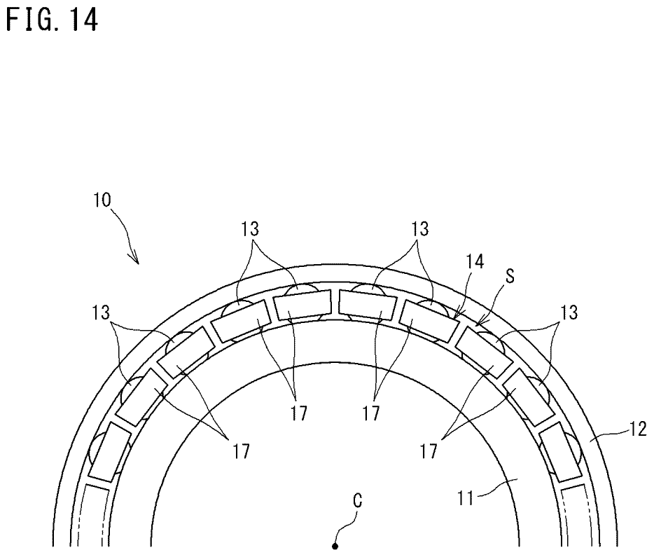

FIG. 13 is a sectional view showing still another embodiment of the rolling bearing. The rolling bearing 10 shown in FIG. 13 is a tapered roller bearing, and the rollers 13 provided between the inner ring 11 and the outer ring 12 are tapered rollers. Regarding the rolling bearing 10 shown in FIG. 13, the same configurations as those of the rolling bearing 10 shown in FIG. 1 are denoted by the same signs, and description of the same configurations will be omitted. As shown in FIG. 14, the cage 14 of the rolling bearing 10 according to the third embodiment is composed of a plurality of cage segments 17. The plurality of cage segments 17 is located in an annular space S between the inner ring 11 and the outer ring 12. One roller 13 is held in one cage segment 17.

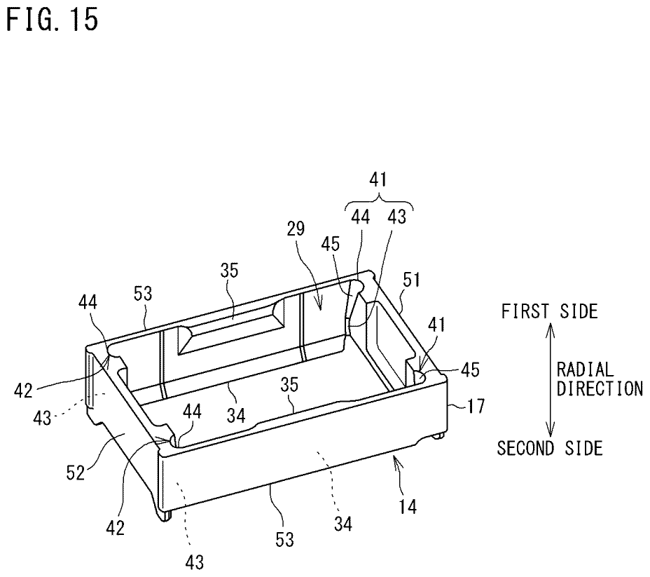

FIG. 15 is a perspective view of a cage segment 17. The cage segment 17 has a first wall 51, a second wall 52, and two bars 53. The first wall 51 faces the first end face 26 of the roller 13 (see FIG. 13). The second wall 52 faces the second end face 27 of the roller 13. The bars 53 connect the first wall 51 and the second wall 52. The bars 53 face the outer peripheral surface 28 of the roller 13. The space between the pair of bars 53 and between the first wall 51 and the second wall 52 serves as a pocket 29 that stores the roller 13.

The bars 53 each have, on the outer peripheral side of the cage segment 17, an outer retaining portion 35 that prevents the roller 13 stored in the pocket 29 from falling out. The retaining portion 35 is a protrusion protruding from the bar 53. When the roller 13 stored in the pocket 29 is displaced outward in the radial direction of the cage 14, the roller 13 comes into contact with the retaining portions 35 and is prevented from falling out. The bars 53 each have, on the inner peripheral side of the cage segment 17, an inner retaining portion 34 that prevents the roller 13 stored in the pocket 29 from falling out. The retaining portion 34 is a protrusion protruding from the bar 53. When the roller 13 stored in the pocket 29 is displaced inward in the radial direction of the cage 14, the roller 13 comes into contact with the retaining portions 34 and is prevented from falling out.

A method for assembling the rolling bearing 10 shown in FIG. 13 is as follows. The rollers 13 are installed into the pockets 29 of the cage segments 17. The rollers 13 are installed into the pockets 29 from the outer peripheral side of the cage segments 17. When looking at one cage segment 17 (see FIG. 15), the dimension between the two outer retaining portions 35 is smaller than the diameter of the roller 13 at the position where these retaining portions 35 are formed. Therefore, when installing a roller 13 into the pocket 29, the roller 13 presses the outer retaining portions 35, so that the bars 53 are elastically deformed. All of the rollers 13 are installed into the cage segments 17 to form a roller and cage assembly. The roller and cage assembly is combined with the inner ring 11 and then with the outer ring 12 to form the rolling bearing 10.

In FIG. 15, a portion where the first wall 51 and one bar 53 are connected is a first connection portion 41. A portion where the second wall 52 and one bar 53 are connected is a second connection portion 42. There are two first connection portions 41 in one cage segment 17, and there are two second connection portions 42 in one cage segment 17.

The first connection portion 41 has a concave arc surface 43 located on the inner peripheral side and a recessed surface 44 located on the outer peripheral side. The concave arc surface 43 is a surface having a shape conforming to a cylinder with a very small radius. The recessed surface 44 is a surface that is recessed more than the concave arc surface 43. The concave arc surface 43 and the recessed surface 44 are also provided in the second connection portion 42. That is, the second connection portion 42 has a concave arc surface 43 located on the inner peripheral side and a recessed surface 44 located on the outer peripheral side. The concave arc surface 43 of the first connection portion 41 and the concave arc surface 43 of the second connection portion 42 have the same shape, and the recessed surface 44 of the first connection portion 41 and the recessed surface 44 of the second connection portion 42 have the same shape.

The recessed surface 44 is a surface having a shape conforming to a cone. The recessed surface 44 has a tilted surface 45 that makes the recess gradually deeper away from the concave arc surface 43 in the radial direction, i.e., toward the outer peripheral side. The clearance between the recessed surface 44 and the end face 26 (27) of the roller 13 (see FIG. 13) becomes gradually larger toward the outer peripheral side due to the tilted surface 45. The shapes of the concave arc surface 43 and the recessed surface 44 are the same as in the first embodiment (FIGS. 6 and 7).

### Regarding Rolling Bearing 10 and Cage 14 of Each Embodiment

As described above, the cage 14 of the rolling bearing 10 of each embodiment described above includes the first annular body 31 (first wall 51) facing the first end faces 26 of the rollers 13, the second annular body 32 (second wall 52) facing the second end faces 27 of the rollers 13, and the plurality of bars 33 (bars 53) connecting the first annular body 31 (first wall 51) and the second annular body 32 (second wall 52). The space between a pair of bars 33 (bars 53) and between the first annular body 31 (first wall 51) and the second annular body 32 (second wall 52) serves as a pocket 29 that stores a roller 13.

The bars 33 (bars 53) each have, on a first side in the radial direction, the retaining portions that prevent the roller 13 stored in the pocket 29 from falling out. In the case of the cage 14 of the first embodiment (see FIGS. 3 and 4) and in the case of the cage 14 of the second embodiment (see FIG. 11), the first side in the radial direction is the inner peripheral side of the cage 14, and the second side in the radial direction is the outer peripheral side of the cage 14. In the case of the cage 14 (cage segment 17) of the third embodiment (see FIG. 15), the first side in the radial direction is the outer peripheral side of the cage 14 (cage segment 17), and the second side in the radial direction is the inner peripheral side of the cage 14 (cage segment 17).

In the cage 14 of each embodiment described above, the first connection portion 41 between the first annular body 31 (first wall 51) and the bar 33 (bar 53) has the concave arc surface 43 located on the second side in the radial direction and the recessed surface 44 located on the first side in the radial direction. The recessed surface 44 is recessed more than the concave arc surface. The method for assembling the rolling bearing 10 including the cage 14 of each embodiment described above includes a combining step of installing the rollers 13 into the pockets 29 from the first side in the radial direction to obtain a unit of the cage 14 and the rollers 13. In the combining step, the rollers 13 press the retaining portions and elastically deform the bars 33 (bars 53), so that the rollers 13 are installed into the pockets 29.

The bars 33 (bars 53) are elastically deformed in order to allow the rollers 13 to be installed into the pockets 29. Even in this case, the cage 14 can reduce stress concentration on the first connection portion 41 by the recessed surface 44. The recessed surface 44 is present on the first side in the radial direction, but is not present on the second side in the radial direction. This provides a larger contact area between the first end face 26 of the roller 13 and the first annular body 31 (first wall 51) than in the conventional example. Wear of the cage 14 due to reduction in the contact area can thus be reduced.

The recessed surface 44 is present on the first side in the radial direction, but is not present on the second side in the radial direction. This reduces a decrease in strength of the cage 14. In the cage 14 of each embodiment described above, the recessed surface 44 increases the length of the portion of the bar 33 (bar 53) that is elastically deformed. This facilitates installation of the roller 13 into the pocket 29.

In the first and third embodiments, the second connection portion 42 between the second annular body 32 (second wall 52) and the bar 33 (bar 53) has the concave arc surface 43 located on the second side in the radial direction and the recessed surface 44 located on the first side in the radial direction, like the first connection portion 41. The recessed surface 44 is recessed more than the concave arc surface 43. This provides a larger contact area between the second end face 27 of the roller 13 and the second annular body 32 (second wall 52) than in the conventional example.

In each of the above embodiments, the recessed surface 44 has such a tilted surface 45 that the clearance between the recessed surface 44 and the roller 13 becomes gradually larger away from the concave arc surface 43 in the radial direction. The tilted surface 45 provides a larger contact area between the first end face 26 of the roller 13 and the first annular body 31 (first wall 51) without sacrificing the function to reduce the stress concentration.

### Others

In each of the above embodiments, the recessed surface (first concave surface) 44 that is continuous with the concave arc surface (second concave surface) 43 has a shape conforming to a cone. However, the recessed surface 44 may have other shapes. Although not shown in the figures, the recessed surface 44 may have a surface having a shape conforming to a larger cylinder than the concave arc surface 43. For example, the recessed surface 44 may be composed of a surface having a shape conforming to a larger cylinder than the concave arc surface 43 and a surface having a shape conforming to a cone.

In each of the above embodiments, the boundary between the concave arc surface 43 and the recessed surface 44 is located at an intermediate position in the radial direction of the first connection portion 41 (second connection portion 42). The concave arc surface 43 may be formed along a greater length in the radial direction than the recessed surface 44, or the recessed surface 44 may be formed along a greater length in the radial direction than the concave arc surface 43. When the concave arc surface 43 is formed along a greater length, the contact area is increased. When the recessed surface 44 is formed along a greater length, the function to reduce the stress concentration is enhanced.

As described in each of the above embodiments, the shape of the cage may vary depending on the form of the rolling bearing, that is, depending on the rolling elements of the rolling bearing.

The above embodiments are illustrative in all respects and not restrictive. The scope of the present invention is shown by the claims rather than by the above embodiments, and is intended to include all modifications within the scope equivalent to that of the configurations described in the claims.

### DESCRIPTION OF THE REFERENCE NUMERALS

10 . . . rolling bearing, 11 . . . inner ring, 12 . . . outer ring, 13 . . . roller, 14 . . . cage, 17 . . . cage segment, 26 . . . first end face, 27 . . . second end face, 29 . . . pocket, 31 . . . first annular body (first wall), 32 . . . second annular body (second wall), 33 . . . bar, 34 . . . retaining portion, 35 . . . retaining portion, 41 . . . first connection portion (connection portion), 42 . . . second connection portion, 43 . . . concave arc surface (second concave surface), 44 . . . recessed surface (first concave surface), 44e . . . end, 45 . . . tilted surface, 46 . . . connecting surface, 46e . . . edge, 51 . . . first wall, 52 . . . second wall, 53 . . . bar

1. A cage including a first wall facing a first end face of a roller of a rolling bearing, a second wall facing a second end face of the roller, and a plurality of bars connecting the first wall and the second wall, a space between a pair of the bars and between the first wall and the second wall serving as a pocket that stores the roller, wherein:
the bar includes, on either or both of a first side and a second side in a radial direction, a retaining portion that prevents the roller stored in the pocket from falling out;
a connection portion between the first wall and the bar includes a first concave surface located on the first side in the radial direction and a second concave surface located on the second side in the radial direction, the first concave surface being recessed more than the second concave surface;
the first concave surface includes such a tilted surface that a clearance between the first concave surface and the roller becomes gradually larger away from the second concave surface in the radial direction;
the cage is made of resin;
the first wall includes a connecting surface that connects the first concave surface located at one bar of the pair of bars adjacent to each other and the first concave surface located at the other bar; and
the connecting surface is such a surface that a clearance between the connecting surface and the roller becomes gradually larger toward the first side in the radial direction.

2. (canceled)

3. (canceled)

4. The cage according to claim 1, wherein:
the first wall is a first annular body having a ring shape; and
the second wall is a second annular body having a ring shape.

5. The cage according to claim 1, wherein:
the cage is composed of a plurality of cage segments located in an annular space between an inner ring and an outer ring of the rolling bearing; and
each of the cage segments includes the first wall, the second wall, and two of the bars.

6. The cage according to claim 1, wherein an edge on the second side in the radial direction of the connecting surface is located closer to the first side in the radial direction than an end on the second side in the radial direction of the first concave surface located at the one bar and an end on the second side in the radial direction of the first concave surface located at the other bar.

7. A rolling bearing comprising:
an inner ring;
an outer ring;
a plurality of rollers located between the inner ring and the outer ring; and
a cage that holds the rollers, wherein
the cage is the cage according to claim 1.

8. A method for assembling the rolling bearing according to claim 7, the method comprising a combining step of installing the rollers into the pockets from either or both of the first side and the second side in the radial direction to obtain a unit of the cage and the rollers, wherein in the combining step, the rollers are installed into the pockets in such a manner that the rollers press the retaining portions to elastically deform the bars.
